(19) United States
(12) Patent Application Publication
(10) Pub. No.: US 2012/0129028 A1
(43) Pub. Date: May 24, 2012

(54) BATTERY BOX

(76) Inventor: MEI-LING PENG, Taipei City (TW)

(21) Appl. No.: 12/954,602

(22) Filed: Nov. 24, 2010

(51) Int. Cl. H01M 2/10

(52) U.S. Cl. 429/100

(57) ABSTRACT

A battery box includes a receptacle and a cover. The receptacle has a front wall having an outside surface to which two laterally-spaced connection blocks are mounted and including a positive terminal conductor and a negative terminal conductor arranged between the two connection blocks. The receptacle has a rear wall having an outside surface in which two laterally-spaced connection slots are formed and including a positive terminal connector and a negative terminal connector arranged between the two connection slots. The receptacle include a positive electrode contact and a negative electrode contact respectively mounted to inside surfaces of the front and rear walls. Connection wirings are provided to respectively connect the positive terminal conductor and the positive terminal connector to the positive electrode contact and to connect the negative terminal conductor and the negative terminal connector to the negative electrode contact.

### (a) TECHNICAL FIELD OF THE INVENTION

The present invention generally relates to a battery box, which can be used to individually operate for supply of power or alternatively multiple such battery boxes can be connected together to form a parallel-connected circuit for supply of power.

### (b) DESCRIPTION OF THE PRIOR ART

A conventional battery box is shown in FIG. 1 of the attached drawings. The conventional battery box, generally designated at 1, comprises a receptacle or holder in which a battery 2 is received, and is connectable with a socket 3 to which a miniature LED (Light-Emitting Diode) based lighting device or a Christmas light string that consumes direct-current power is pluggable to supply electrical power to such an electrical appliance. Such a conventional battery box 1 has certain drawbacks, of which one is that a number of batteries 2 must be simultaneously set in the receptacle in order to supply a large power, wherein all the batteries 2 are arranged in series connection. One of the drawbacks of series connection of batteries is that the output voltage increases with the number of batteries included in the battery box. Due to such a situation, a lighting device connected to such a battery box must be operated with a passive element, such as an electrical resistor, in order to reduce the voltage applied thereto. This makes it not possible to completely use the electrical current supplied from the batteries 2, which in turn leads to shortening of the service life of the batteries 2. Another problem is that the conventional battery box 1, when designed to accommodate a number of batteries, is capable of receiving and holding therein a fixed number of batteries, making it not possible to increase or decrease the number of the batteries accommodated therein to suit the need of different lighting devices or different applications. Apparently, improvement is desired for such a battery box.

### SUMMARY OF THE INVENTION

In view of the above discussed problems of the conventional battery box, the present invention aims to provide an improvement for such type of battery box in order to overcome the drawbacks discussed above.

According to the present invention an improved battery box is provided, comprising a receptacle and a cover. The receptacle has a front wall having an outside surface forming two laterally spaced connection blocks and a rear wall having an outside surface forming two laterally-spaced connection slots. A positive terminal conductor and a negative terminal conductor are mounted to the front wall of the receptacle between the two connection blocks, and a positive terminal connector and a negative terminal connector are mounted to the rear wall of the receptacle between the two connection slots. The receptacle comprises a positive electrode contact mounted to an inside surface of the front wall and a negative electrode contact mounted to an inside surface of the rear wall. Connection wirings are respectively formed to connect the positive terminal conductor and the positive terminal connector to the positive electrode contact and connect the negative terminal conductor and the negative terminal connector to the negative electrode contact.

With a battery received in the battery box, the battery box is selectively incorporated with a socket or multiple such battery boxes are mechanically connectable together and form a parallel-connected circuit for power supply.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a convention arrangement of battery box.

FIG. 2 is an exploded view of a battery box according to the present invention.

FIG. 3 is a perspective view of the battery box according to the present invention in an assembled form.

FIG. 4 is a top view of a receptacle of the battery box according to the present invention.

FIG. 5 is a schematic view illustrating an example of application of the battery box according to the present invention.

FIG. 6 is a schematic top view showing a modification of the battery box according to the present invention.

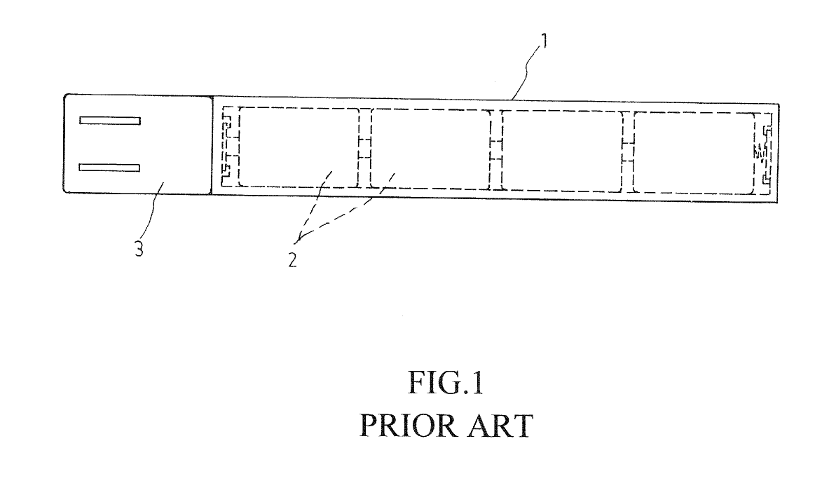

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

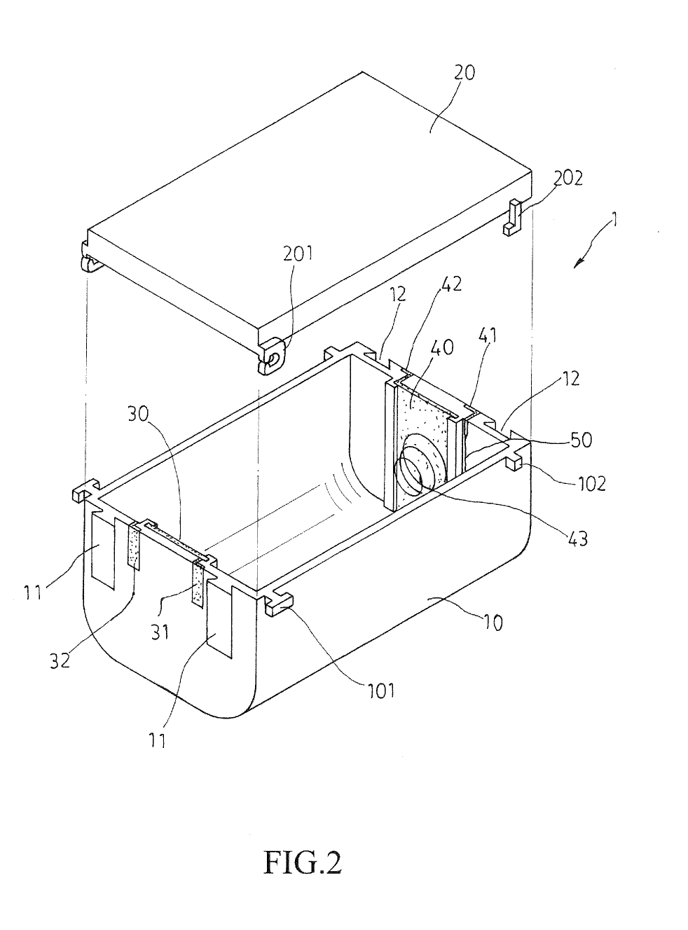

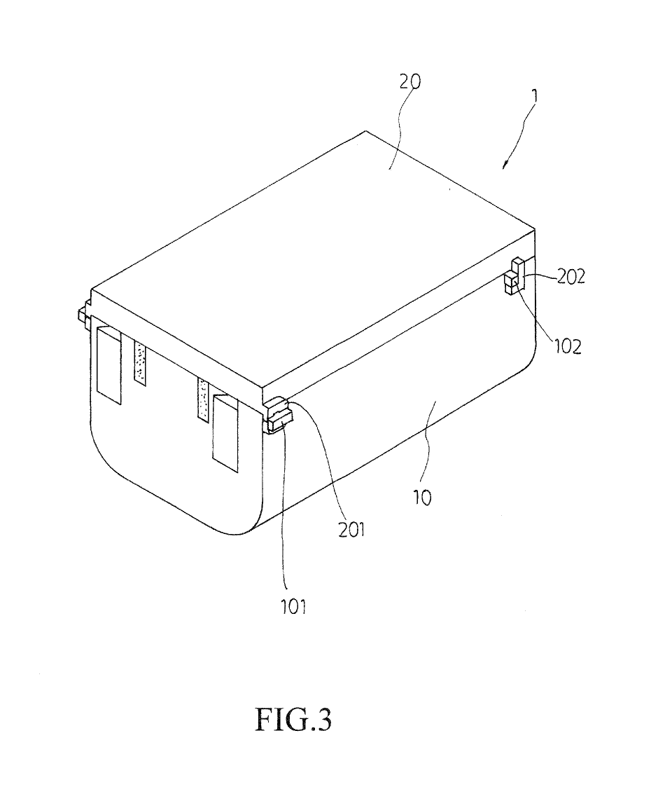

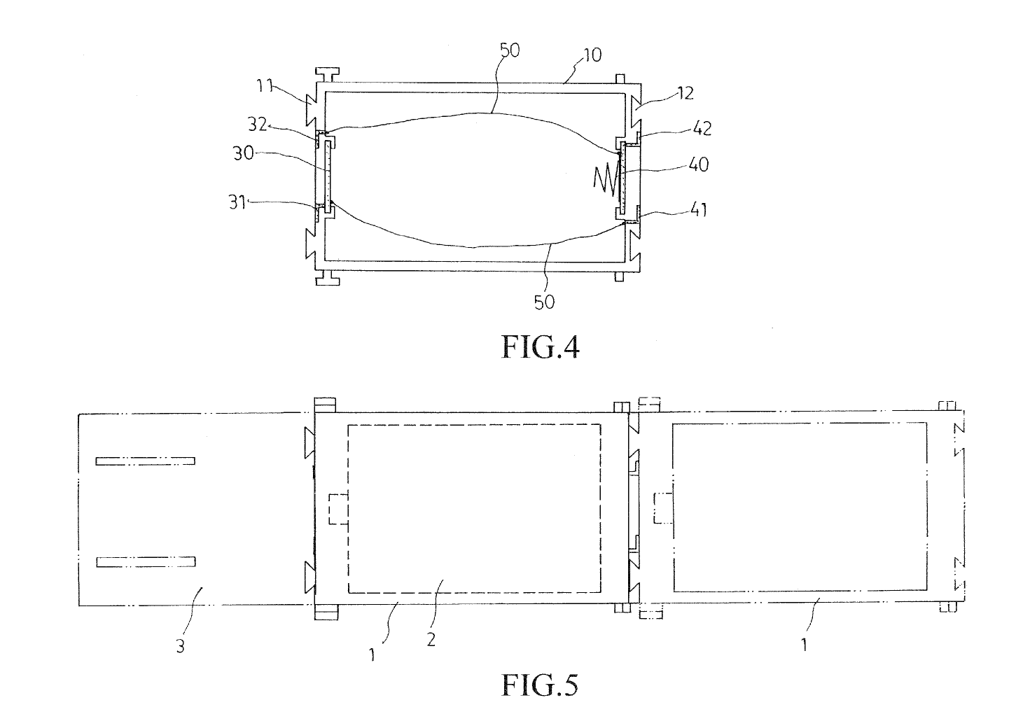

Referring to FIGS. 2-4, the present invention provides an improved battery box 1, which is composed of a receptacle 10 and a cover 20. The receptacle 10 has a front wall having an inside surface on which a positive electrode contact 30 mounted and a rear wall having an inside surface on which a negative electrode contact 40 that is provided with a support spring 43 is mounted. The receptacle 10 has two side walls each having front and rear ends respectively forming a front retention block 101 and a rear retention block 102. The cover 20 has two side faces each having front and rear ends respectively forming a pawl 201 and a hook 202. The cover 20 is positionable on the receptacle 10 to have the front retention blocks 101 received into the pawls 201 for retention therein and the hooks 202 hooking the rear retention blocks 102, whereby a secured retention engagement is formed between the receptacle 10 and the cover 20. The receptacle 10 comprises two laterally spaced connection blocks 11 mounted to an outside surface of the front wall thereof, and also forms laterally spaced connection slots in an outside surface of the rear wall thereof. A positive terminal conductor 31 and a negative terminal conductor 32 are mounted to the front wall of the receptacle 10 between the two connection blocks 11; and a positive terminal connector 41 and a negative terminal connector 42 are mounted to the rear wall of the receptacle 10 between the two connection slots 12. Connection wiring is formed to connect both the positive terminal conductor 31 and the positive terminal connector 41 to the positive electrode contact 30; and connection wiring 50 is formed to connect both the negative terminal conductor 32 and the negative terminal connector 42 to the negative electrode contact 40. With a battery 2 received in the battery box 1, this arrangement allows the battery box 1 to be incorporated with a voltage-boosting socket 3, and since each individual battery box 1 according to the present invention shows a parallel-connectable circuit arrangement, a plurality of such battery boxes 1 can be mechanically connected together with the above described structure and form a parallel-connected circuit for power suppl.

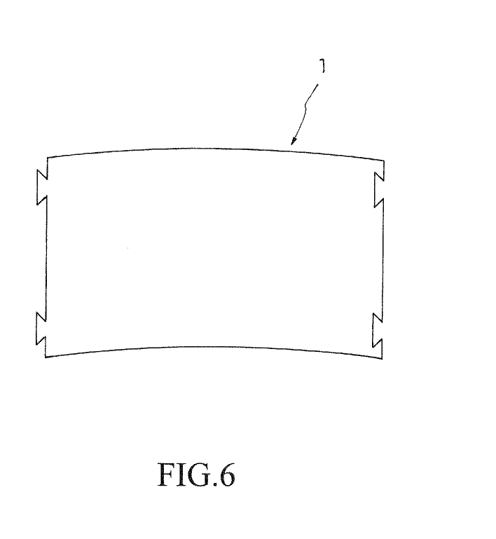

Referring to FIG. 6, the battery box 1 according to the present invention can be modifiable at least for the outside configuration so as to form a curved outside contour, which allows multiple battery boxes 1 to joint together to form an arc configuration. It is certain that other shapes or configurations may be adopted for the battery box 1 of the present invention.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A battery box, comprising a receptacle and a cover that are coupled to each other through mechanical retention engagement, the receptacle having a front wall having an inside surface to which a positive electrode contact mounted and a rear wall having an inside surface to which a negative electrode contact is mounted, the improvements comprising that the receptacle comprises two spaced connection blocks mounted to an outside surface of the front wall thereof, and a positive terminal conductor and a negative terminal conductor mounted to the front wall between the two connection blocks; the receptacle forms two connection slots in the rear wall thereof and forms a positive terminal connector and a negative terminal connector between the two connection slots; and connection wiring is formed to connect the positive terminal conductor and the positive terminal connector to the positive electrode contact, and connection wiring is formed to connect the negative terminal conductor and the negative terminal connector to the negative electrode contact, whereby with a battery received in the battery box, the battery box is selectively incorporated with a socket or multiple such battery boxes are mechanically connectable together and form a parallel-connected circuit for power supply.

2. The battery box according to claim 1, wherein the receptacle has two side walls each having front and rear ends respectively forming a front retention block and a rear retention block and the cover has two side faces each having front and rear ends respectively forming a pawl and a hook, the cover being positionable on the receptacle to have the front retention blocks received into the pawls for retention therein and the hooks hooking the rear retention blocks, whereby a secured retention engagement is formed between the receptacle and the cover.

3. The battery box according to claim 1, wherein the connection blocks formed on the front wall of the receptacle and the connection slots formed on the rear wall of the receptacle are replaceable by other mateable connection structures.

4. The battery box according to claim 1, wherein the battery box has a curved outside contour, which allows multiple battery boxes to joint together to form an arc configuration; and wherein the battery box adopts an outer contour of other shapes.

5. The battery box according to claim 1, wherein the socket comprises therein a boosting circuit to provide a voltage match with an electrical appliance connected thereto.

6. The battery box according to claim 2, wherein the receptacle and the cover are secured to each other through other retention engagement.
